(19) United States
(12) Patent Application Publication
(10) Pub. No.: US 2021/0201705 A1
(43) Pub. Date: Jul. 1, 2021

(54) Sealing Device for Sealing at least one Storage and/or Packaging Device for Durable Goods, particularly Machine Tools, and/or for Sealing at least one Piece of Information

(71) Applicant: Robert Bosch GmbH, Stuttgart (DE)

(72) Inventors: Joachim Schadow, Stuttgart (DE); Benjamin Schmitt, Stuttgart (DE); Florian Esenwein, Leinfelden-Echterdingen (DE)

(21) Appl. No.: 17/051,395

(22) PCT Filed: Jul. 27, 2018
(86) PCT No.: PCT/EP2018/070443

§ 371 Date: Oct. 28, 2020

(30) Foreign Application Priority Data
Sep. 20, 2017 (DE) 10 2017 216 628.2

(51) Int. Cl. G09F 3/03; G09F 3/00

(52) U.S. Cl. CPC G09F 3/0341; G09F 2003/0272; G09F 3/0297; G09F 3/0292

(57) ABSTRACT

A sealing device for sealing at least one storage and/or packaging device for durable goods, particularly machine tools, and/or for sealing at least one piece of information includes at least one information carrier unit for receiving the at least one piece of information and/or a security key, particularly durable-goods-specific information and/or a durable-goods-specific security key. The sealing device also includes at least one fastening unit, particularly an adhesive unit for fastening at least the information carrier unit to the storage and/or packaging device or to the durable goods, particularly machine tools. The sealing device further includes at least one sealing unit for an at least substantially irreversible visualisation, for the first time, of the information carrier unit and/or a first-time opening of the storage and/or packaging unit. The sealing unit covers at least the information carrier unit in the at least one sealing state such that it cannot be seen.

### PRIOR ART

There has already been proposed a sealing device for sealing at least one storage and/or packaging device for durable goods, in particular power tools, comprising at least one information carrier unit for receiving at least one item of information and/or security key, and comprising at least one fixing unit for fixing at least the information carrier unit to the storage and/or packaging device.

### DISCLOSURE OF THE INVENTION

The invention is based on a sealing device for sealing at least one storage and/or packaging device for durable goods, in particular, power tools, and/or for sealing at least one item of information, in particular durable-good-specific information, and/or durable-good-specific security key, comprising at least one information carrier unit for receiving at least one item of information and/or security key, in particular durable-good-specific information and/or durable-good-specific security key, and comprising at least one fixing unit, in particular adhesive unit, for fixing at least the information carrier unit to the storage and/or packaging device or to the durable good, in particular power tool.

It is proposed that the sealing device comprise at least one sealing unit for an at least substantially irreversible visualization of a first-time viewing of the information carrier unit and/or a first-time opening of the storage and/or packaging device, wherein the sealing unit, in at least one sealing state, covers at least the information carrier unit in a visually protected manner. Preferably, the sealing unit bears against the information carrier unit, in particular flatly, in at least one sealing state of the sealing unit. Preferably, in at least one sealing state of the sealing unit, the sealing unit covers at least one sub-region of the information carrier unit that receives the information and/or the security key, in particular the durable-good-specific information and/or the durable-good-specific security key, in a visually protected manner. Particularly preferably, in at least one sealing state of the sealing unit, the sealing unit covers the information carrier unit completely. “Concealed in a visually protected manner” is to be understood to mean, in particular, an arrangement of an element and/or of a unit that, in at least one state, is invisible at least to a human eye, such that, in this state, in particular at least one item of information of the element and/or of the unit, or the element and/or the unit itself, is/are undetectable at least by a human eye, in particular as a result of the element and/or the unit being physically covered by a further element and/or a further unit. Preferably, in at least one sealing state of the sealing unit, the sealing unit covers the information carrier unit and, at least partially, in particular completely, the fixing unit, in a visually protected manner. The sealing unit preferably comprises at least, in particular precisely, one non-transparent sub-region, in particular a covering element, and at least one transparent sub-region, in particular an indication element realized as an adhesive layer. The non-transparent sub-region and the transparent sub-region may be realized in one piece, in particular as one layer, or as separate sub-regions that are fixed to one another by means of a force-locking, form-locking and/or materially bonded connection. Preferably, the transparent sub-region overlaps the non-transparent sub-region on at least two sides, in particular as viewed in one plane. Preferably, the transparent sub-region has a maximum projection, relative to the non-transparent sub-region, that in particular is less than 100 mm, preferably less than 25 mm, and particularly preferably greater than 2 mm. Preferably, the transparent region has a maximum projection, relative to the non-transparent region, that corresponds to a value from a value range of from 8 mm to 20 mm. It is also conceivable, however, for the sealing unit to be formed entirely from a non-transparent layer, in particular a film layer, and an adhesive layer arranged inseparably thereon, which is arranged at least on one side of the non-transparent layer, in particular in at least one edge region of the non-transparent layer. Other designs of the sealing unit for a visually protected covering of at least the information carrier unit, that are considered appropriate by persons skilled in the art, are also conceivable. The sealing device is preferably realized as a security and/or seal label. Preferably, a sealing state of the sealing unit is intended to define an unopened state of a seal point of the sealing unit, a non-detached state of an adhesive layer and/or a haptically and/or optically unchanged state of the sealing unit.

In particular, the sealing unit is realized as a mechanical sealing unit for an at least substantially irreversible visualization of a first-time viewing of the information carrier unit and/or a first-time opening of the storage and/or packaging device. Preferably, for an at least substantially irreversible visualization of a first-time viewing of the information carrier unit and/or a first-time opening of the storage and/or packaging device, the sealing unit is realized in such a manner that the sealing unit has at least one sealing parting point that can be irreversibly severed, or the sealing unit has at least one sub-region, in particular at least one adhesive region, that can be changed optically and/or haptically, in particular as a result of attempted removal, or removal, of the adhesive region, in particular from the storage and/or packaging device. However, it is also conceivable for the sealing unit, for an at least substantially irreversible visualization of a first-time viewing of the information carrier unit and/or a first-time opening of the storage and/or packaging device, to be realized as an electrical and/or electronic sealing unit, which emits and/or stores an electrical and/or electronic signal in dependence on a first-time viewing and/or first-time opening. The sealing unit may have at least one electronic data element, such as, for example, an NFC data element, a Bluetooth data element, an RFID data element or the like, which may be provided, in particular, for communication with an external unit, in particular for transmitting notices and/or instructions, which, quite preferably, are different from the information received by the information carrier unit and/or from the security key received by the information carrier unit.

The information carrier unit is preferably realized as a booklet. Preferably, in at least one sealing state of the sealing unit, the booklet is arranged, folded up, on the fixing unit, in particular between the fixing unit and the sealing unit. The information carrier unit, in particular in a folded state, preferably has a maximum dimension of 110 mm×80 mm, preferably of 90 mm×54 mm, and very preferably a maximum dimension, in accordance with ID-1, ISO/IEC 7810, of 85.60 mm×53.98 mm, with deviations of, in particular, maximally +/−20% and preferably maximally +/−5% from the above-mentioned values being possible for production reasons. Preferably, the information carrier unit, realized as a booklet, has at least one filing interface such as, for example, a perforation for filing in a file folder.

The information and/or the security key, in particular the durable-good-specific information and/or the durable-good-specific security key, may be imprinted, glued, embossed, etched or impressed, on/in at least one information carrier element of the information carrier unit, or arranged on the information carrier unit in any other manner considered appropriate by persons skilled in the art. Preferably, the information and/or the security key, in particular the durable-good-specific information and/or the durable-good-specific security key, is/are arranged on the information carrier element in the form of a machine-readable code such as, for example, a QR code, a data matrix code, a barcode or the like. Preferably the information and/or the security key, in particular the durable-good-specific information and/or the durable-good-specific security key, is/are designed to be used to assign a durable good, in particular a power tool, to a user and/or to generate a certificate of a durable good, in particular a power tool, in particular as a result of an input and/or a transmission to a data processing centre. “Designed” is to be understood to mean, in particular, specially configured and/or specially equipped. That an object is designed for a particular function, is to be understood to mean, in particular, that the object fulfils and/or executes this particular function in at least one application state and/or operating state. A “durable good” is to be understood to mean, in particular, a good that can be used by a person to perform an activity. The durable good may be realized, for example, as a tool, an insert tool, a power tool, in particular a portable power tool, a desktop PC, a laptop, a printer, a scanner, a camera, a camcorder, a mobile telephone, an item of entertainment electronics, or the like. Preferably, the durable good is realized as an electrically powered durable good such as, for example, a smartphone, a tablet, a power tool, in particular a portable power tool, or the like. A “portable power tool” is to be understood here to mean, in particular, a power tool, for performing work on workpieces, that can be transported by an operator without the use of a transport machine. The portable power tool has, in particular, a mass of less than 40 kg, preferably less than 10 kg, and particularly preferably less than 5 kg.

The design of the sealing device according to the invention makes it possible, advantageously, to reliably protect the information carrier unit against viewing of the information received by the information carrier unit and/or of the security key received by the information carrier.

Furthermore, it is proposed that the sealing unit comprise at least one covering element which, in at least one sealing state of the sealing unit, covers at least the information carrier unit in a visually protected manner, and at least one indication element, which is arranged on the covering element and which is at least partially transparent. The covering element is preferably non-transparent. The indication element preferably covers the covering element completely. The indication element preferably forms a top layer of the sealing unit, in at least one sealing state of the sealing unit. It is also conceivable, however, for the indication element to be formed on the covering element at side edges of the covering element, and the covering element, together with the indication element, to form a top layer of the sealing unit, in at least one sealing state of the sealing unit. The covering element is preferably connected to the indication element in a materially bonded manner, in particular stuck onto the indication element. It is also conceivable, however, for the covering element and the indication element to be to be realized as a single piece with each other, in particular to be realized as one film layer. The indication element preferably comprises an adhesive layer, which is provided for fixing the sealing unit to the storage and/or packaging device. In particular, at least the covering element comprises a predetermined parting point, in particular a sealing parting point such as, for example, a perforation, a tear-open strip or the like. Preferably, at least the indication element comprises a predetermined parting point, in particular a seal parting point, such as a perforation, a tear-open strip or the like. Preferably, the predetermined parting point of the covering element and the predetermined parting point of the indication element are arranged congruently in at least one sealing state of the sealing unit. By means of the design according to the invention, information arranged on the covering element, in particular a handling instruction, can advantageously be arranged so as to be visible when the sealing unit is in a sealing state, it being advantageously possible, in particular, for an item of information received by the information carrier unit and/or a security key received by the information carrier unit to be arranged in a visually protected manner.

Further, it is proposed that the sealing unit have at least one indication element which, for at least substantially irreversible visualization of a first-time viewing of the information carrier unit and/or a first-time opening of the storage and/or packaging device, can be changed haptically and/or optically, wherein, in at least one sealing state of the sealing unit, the indication element at least partially surrounds the information carrier unit, in particular as viewed in one plane. Preferably, the indication element surrounds the covering element at least partially, in particular completely. Preferably the indication element is arranged on the covering element at least on at least two sides of the covering element that face away from each other. Particularly preferably, the indication element is arranged on the covering element at least to a large extent, in particular completely, around the covering element.

The indication element is preferably realized as an indicator that, in a manner already known to persons skilled in the art, makes it possible to irreversibly detect any, in particular attempted, detachment of the sealing unit from the storage and/or packaging device, in particular in addition to or as an alternative to severing of the predetermined parting point of the covering element and/or of the predetermined parting point of the indication element. The indication element may be realized, for example, as a pattern film, in which following a, in particular attempted, detachment, a pattern remains on an applied element and the film is irreversibly destroyed, as a VOID film, in which following a, in particular attempted, detachment, a lettering and/or a structure remains on an applied element, as a documentation film that, in the case of a, in particular attempted, detachment, is irreversibly torn into small pieces, as a film with security punching or the like. The design according to the invention makes it possible, advantageously, to reliably protect the information carrier unit against viewing of the information received by the information carrier unit and/or of the security key received by the information carrier, and to easily detect an opened state, in particular a broken-seal state, of the sealing unit. The design according to the invention advantageously makes it possible to achieve reliable protection of the information carrier unit against viewing of the information received by the information carrier unit and/or the security key received by the information carrier unit, and easy detection of an opened state, in particular a broken-seal state, of the sealing unit.

It is additionally proposed that the sealing unit and/or the information carrier unit have/has at least one parting point for non-destructive parting of the sealing unit and/or of the information carrier unit from the fixing unit which, in at least one sealing state of the sealing unit, is covered by the sealing unit so as to be protected from access. Preferably, the sealing unit and the information carrier unit can be detached from the fixing unit when the sealing unit is in an opened state, in particular in a broken-seal state. The fixing unit comprises at least one fixing element, in particular an adhesive layer, and at least one base element, which is designed to receive information. The fixing element may be realized as one piece, in particular as one layer, with the base element, or the fixing element and the base element may be realized as separate elements that are fixed to each other by means of a force-locking, form-locking and/or materially bonded connection. Preferably, the fixing element overlaps the non-transparent sub-region on at least two sides, in particular as viewed in one plane. A maximum extent of the fixing unit is preferably less than a maximum extent of the sealing unit, in particular in order that the fixing unit is securely covered by the sealing unit, in particular in at least one sealing state of the sealing unit. The parting point of the sealing unit and/or of the information carrier unit may be realized, for example, as a perforation, as a tear-open strip or the like. Preferably, the information carrier unit and the sealing unit are fixed, in particular detachably fixed, to the fixing unit, and the sealing unit can be removed from the fixing unit as a result of severing of the parting point of the sealing unit and/or of the information carrier unit, in an opened state, in particular in a broken-seal state. By means of the design according to the invention, advantageously, separation of the sealing unit and/or of the information carrier unit from the fixing unit can advantageously be avoided, in at least one sealing state of the sealing unit. Advantageously, the information carrier unit can be reliably protected against viewing of the information received by the information carrier unit and/or of the security key received by the information carrier unit, and an opened state, in particular a broken-seal state, of the sealing unit is easily detectable.

Furthermore, it is proposed that the information and/or security key of the information carrier unit that is covered in a visually protected by means the sealing unit, in at least one sealing state, be usable as a durable-good-specific code for registering the durable good arranged in the storage and/or packaging device, in particular the power tool arranged in the storage and/or packaging device. Preferably, the information and/or security key of the information carrier unit, realized as a durable-good-specific code, can be used to register the durable good and/or to assign the durable good to a user. Advantageously, secure registration of a durable good, in particular of a power tool, can be achieved. User-specific services can advantageously be assigned to the durable good.

Additionally proposed is a durable good, in particular a power tool, comprising at least one sealing device according to the invention. The durable good may be realized, for example, as a tool, an insert tool, a power tool, in particular a portable power tool, a desktop PC, a laptop, a printer, a scanner, a camera, a camcorder, a mobile telephone, an item of entertainment electronics article or the like. Preferably, the durable good is realized as an electrically powered durable good such as, for example, a smartphone, a tablet, a power tool, in particular a portable power tool or the like. Particularly preferably, the durable good is realized as a portable power tool such as, for example, a hammer drill and/or chisel hammer, a demolition hammer, a power drill, a power sander, a power saw, a planer, a garden appliance or the like. The durable goods may be realized as battery-powered durable goods or as cable-connected durable goods. The design according to the invention advantageously makes it possible to achieve reliable protection of the information carrier unit against viewing of the information received by the information carrier unit and/or the security key received by the information carrier unit. Advantageously, information relating to the durable good, such as, for example, activation keys, can be securely protected. A user can advantageously be provided with a means of easily recognizing information, relating to the durable good, that has already been viewed.

Additionally proposed is a storage and/or packaging device for durable goods, in particular power tools, comprising at least one sealing device according to the invention. The storage and/or packaging device is preferably realized as a case, in particular as a tool case, as a cardboard box, as sales packaging or as another storage and/or packaging device considered appropriate by persons skilled in the art. Preferably, the storage and/or packaging device comprises at least one, in particular further, security and/or seal label, which is arranged on a closure element of the storage and/or packaging device. Preferably, the sealing device, when arranged on the storage and/or packaging device, is arranged at least partially on a lid element of a basic body unit of the storage and/or packaging device and at least partially on a receiving element, in particular a base element, of the basic body unit of the storage and/or packaging device. Preferably, the sealing device extends, in at least one sealing state of the sealing unit, over a closure edge/closure gap between the lid element and the receiving element. Preferably, the lid element and the receiving element are movable relative to each other, in particular at least when the sealing unit is in an opened state. Preferably, the lid element is mounted on the receiving element so as to be pivotable and/or translationally movable. The design according to the invention advantageously makes it possible to achieve reliable protection of the information carrier unit against viewing of the information received by the information carrier unit and/or the security key received by the information carrier unit.

It is additionally proposed that the storage and/or packaging device comprise at least one basic body unit, wherein the fixing unit has at least one item of information, corresponding to the information carrier unit, and/or security key, corresponding to the information carrier unit, which, in at least one sealing state of the sealing device and/or in a broken-seal state of the sealing device, are/is arranged in a visually protected manner on the basic body unit. The broken-seal state is intended here to define, in particular, an opened state of the sealing unit, in particular of the sealing parting point of the sealing unit. Preferably, the item of information, corresponding to the information carrier unit, and/or the security key, corresponding to the information carrier unit, of the fixing unit are/is arranged on a side of the fixing unit that faces away from the sealing unit. Preferably, the item of information, corresponding to the information carrier unit, and/or the security key, corresponding to the information carrier unit, of the fixing unit have/has the same content as the information and/or the security key of the information carrier unit. It is also conceivable, however, for the item of information, corresponding to the information carrier unit, and/or the security key, corresponding to the information carrier unit, of the fixing unit to have a content that is worded differently from the information and/or the security key of the information carrier unit. Preferably, the item of information, corresponding to the information carrier unit, and/or the security key, corresponding to the information carrier unit, of the fixing unit is arranged on the fixing unit in the form of a machine-readable code such as, for example, a QR code, a data matrix code, a barcode or the like. The design according to the invention makes it possible, advantageously, to achieve a reliable registration process and/or a reliable assignment of the durable good in the event of the information carrier unit having been removed or lost. Reliable and secure assignment of the information and/or of the security key can advantageously be achieved even at the time when at least one durable good is inserted in the storage and/or packaging device and the sealing device is attached to the storage and/or packaging device.

Also proposed is a method for assigning a durable good, in particular a power tool, to a user, and/or for generating a certificate, in particular a warranty certificate, guarantee certificate or the like of a durable good, in particular of a power tool, in particular by use of a sealing device according to the invention. The certificate may define, for example, a start timepoint of a guarantee, service and/or warranty period, be realized as a promotion certificate, by means of which, for example, a user is granted a discount for a subsequent purchase, by means of which a user receives a sent product upon registration in an online shop, or the like. The design according to the invention makes it possible, advantageously, to achieve reliable and secure assignment and/or secure generation of a certificate.

It is further proposed that, in at least one method step, a certificate, in particular a service and/or maintenance certificate, is generated in dependence on an input and/or a transmission of at least one item of information and/or security key of the durable good, in particular of the power tool, received by an information carrier unit of a sealing device, and in dependence on an identification of the durable good, in particular of the power tool. Preferably, in at least one method step, the item of information and/or the security key of the durable good can be acquired by means of a mobile acquisition unit, in particular a mobile telephone such as, for example, by means of a smartphone or the like, and transmitted, in particular wirelessly, to a data processing centre. Preferably, in at least one method step, a durable-good ID of the durable good can be acquired by means of a mobile acquisition unit, in particular a mobile telephone such as, for example, by means of a smartphone or the like, and transmitted, in particular wirelessly, to a data processing centre. Preferably, in at least one method step, by means of the data processing centre, a comparison, in particular an automatic comparison, and/or a verification, in particular an automatic verification, of the information and/or the security key and of the durable-good ID, are/is effected by means of the data processing centre. Preferably, in at least one method step, a certificate and/or a start timepoint of a time period relating to the certificate, such as, for example, a start timepoint of a guarantee and/or warranty period, are/is generated, in particular automatically, by means of the data processing centre. Preferably, in at least one method step, a confirmation message is sent, in particular automatically, by means of the data processing centre to the mobile acquisition unit, in particular to indicate a successful assignment and/or certificate generation. By means of the design according to the invention it possible, advantageously, to achieve reliable and secure assignment and/or secure generation of a certificate.

It is additionally proposed that, in at least one method step, a communication unit and/or position data unit of the durable good, in particular of the power tool, is activated automatically in dependence on an input and/or a transmission of at least one item of information and/or security key of the durable good, in particular of the power tool, received by an information carrier unit of a sealing device, and in dependence on an identification of the durable good, in particular of the power tool. Preferably, in at least one method step, activation, in particular automatic activation, of the communication unit and/or position data unit of the durable good is effected by means of the data processing centre, in particular following successful assignment of the durable good to a user and/or following successful generation of a certificate of the durable good. Preferably, in at least one method step, an activation signal is transmitted, in particular wirelessly, by means of the data processing centre to the durable good. It is also conceivable, however, for the activation signal to be transmitted, in particular automatically, in particular wirelessly, by means of the data processing centre to the mobile acquisition unit, which transmits the activation signal to the durable good by means of a, in particular wireless, communication connection such as, for example, a Bluetooth connection. It is conceivable for the activation signal to be transmitted directly or indirectly to the durable good, in particular automatically, by means of the data processing centre. It is also conceivable, alternatively, in at least one method step, for deactivation, in particular automatic deactivation, of the communication unit and/or position data unit of the of the durable good to be effected by means of the data processing centre, in particular following successful assignment of the durable good to a user and/or following successful generation of a certificate of the durable good, in particular in order to protect, for example, the privacy of a user following acquisition of the durable good. A high level of security can advantageously be realized by means of the design according to the invention. Advantageously, a reliable monitoring function can be realized.

The sealing device according to the invention, the storage and/or packaging device according to the invention and/or the method according to the invention are/is not intended in this case to be limited to the application and embodiment described above. In particular, the sealing device according to the invention, the storage and/or packaging device according to the invention and/or the method according to the invention may have individual elements, component parts and units that differ in number from a number stated herein, in order to fulfill an operating principle described herein. Moreover, in the case of the value ranges specified in this disclosure, values lying within the stated limits are also to be deemed as disclosed and applicable in any manner.

Drawing

Further advantages are disclosed by the following description of the drawing. The drawing shows exemplary embodiments of the invention. The drawing, the description and the claims contain numerous features in combination. Persons skilled in the art will also expediently consider the features individually and combine them to create appropriate further combinations.

There are shown:

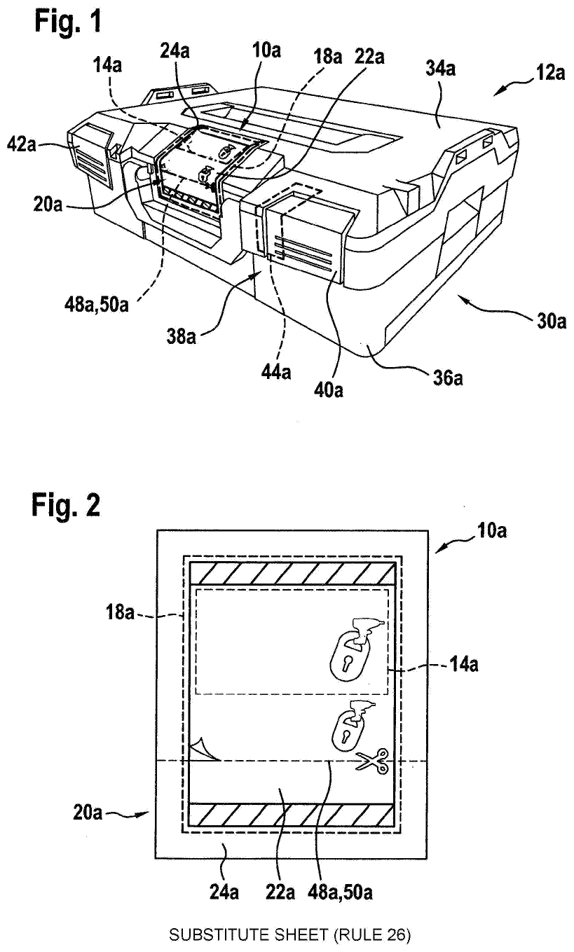

FIG. 1 a storage and/or packaging device according to the invention for durable goods, in particular power tools, having at least one sealing device according to the invention, in a schematic representation,

FIG. 2 the sealing device according to the invention in a sealing state before arrangement on the storage and/or packaging device according to the invention, in a schematic representation,

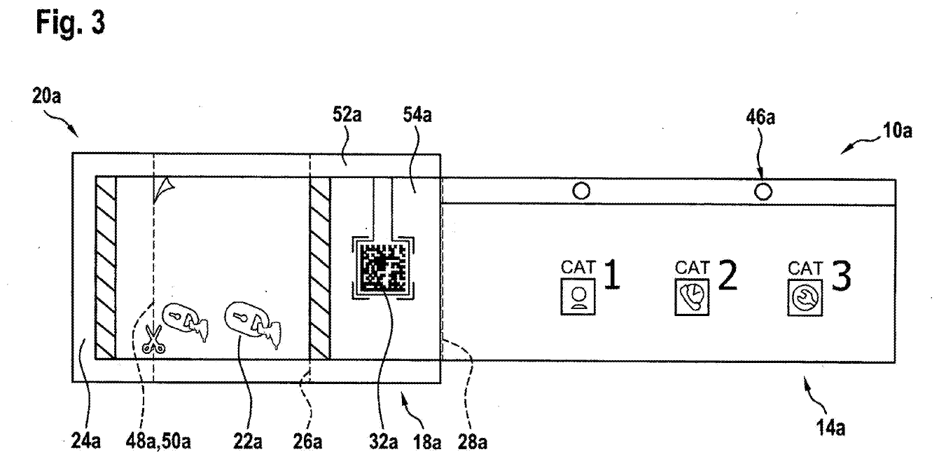

FIG. 3 an upper side of the sealing device according to the invention in a fully unfolded state, in a schematic representation,

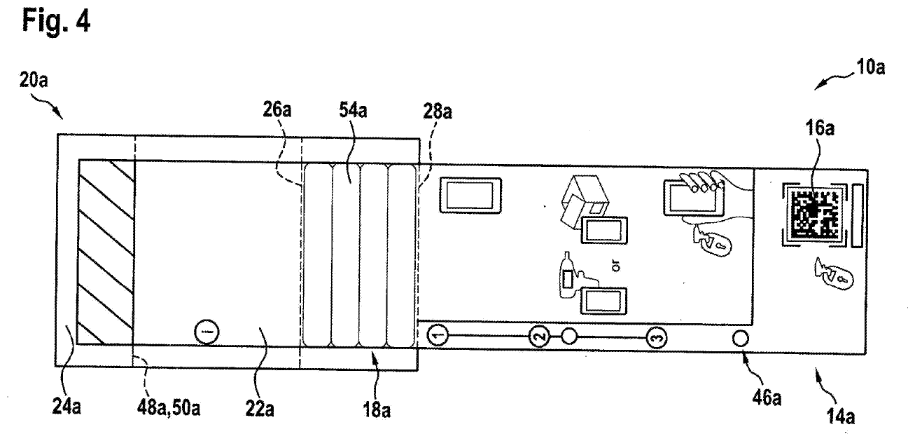

FIG. 4 an underside of the sealing device according to the invention in a fully unfolded state, in a schematic representation,

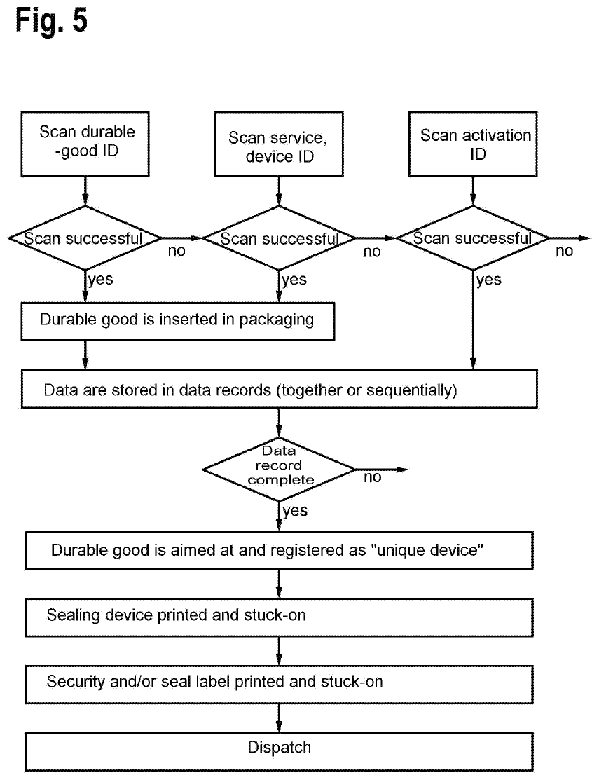

FIG. 5 a flow diagram of a method according to the invention, relating to a production process, in a schematic representation,

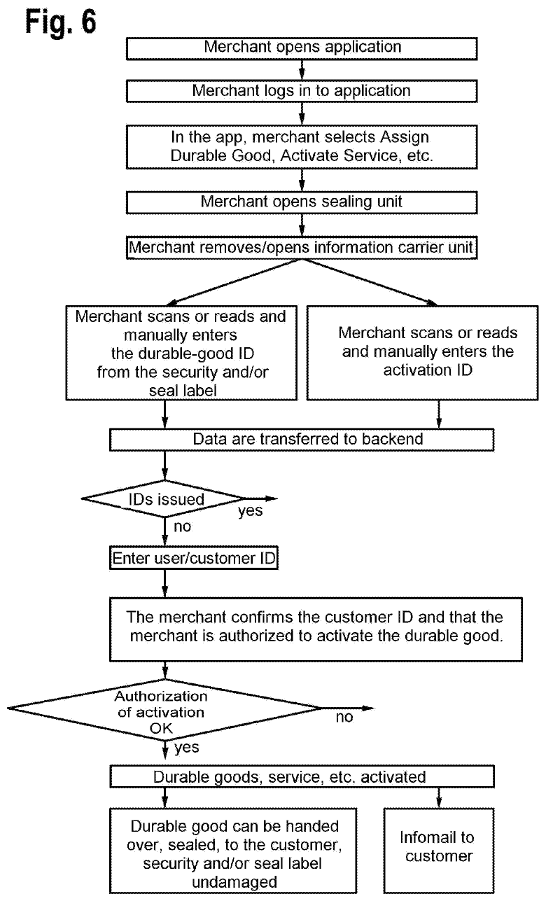

FIG. 6 a flow diagram of the method according to the invention relating to an assignment and/or certificate generation process by a commercial merchant, in a schematic representation,

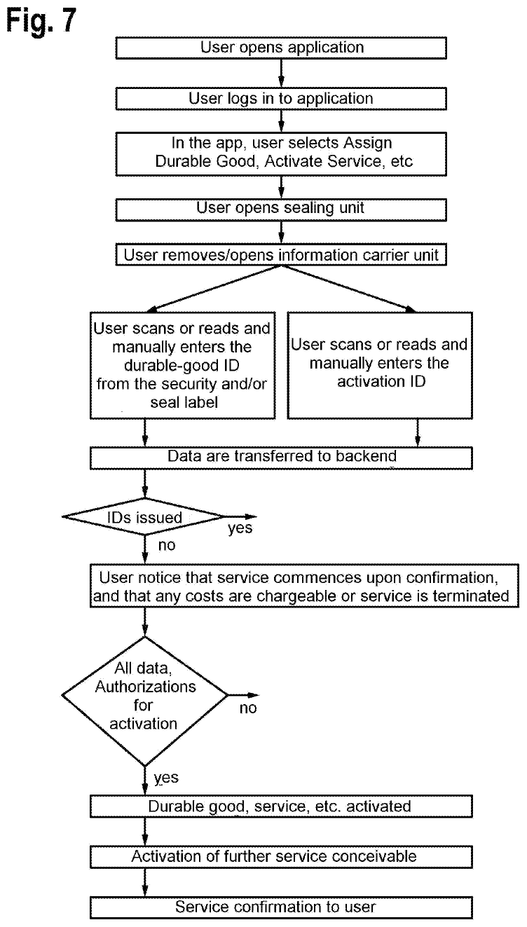

FIG. 7 a flow diagram of the method according to the invention relating to an assignment and/or certificate generation process by an end user, in a schematic representation,

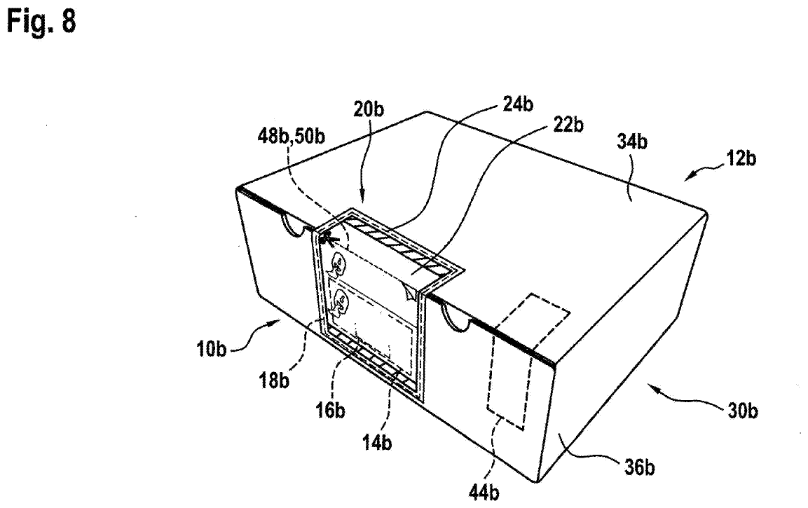

FIG. 8 an alternative storage and/or packaging device according to the invention for durable goods, in particular power tools, having at least one sealing device according to the invention, in a schematic representation, and

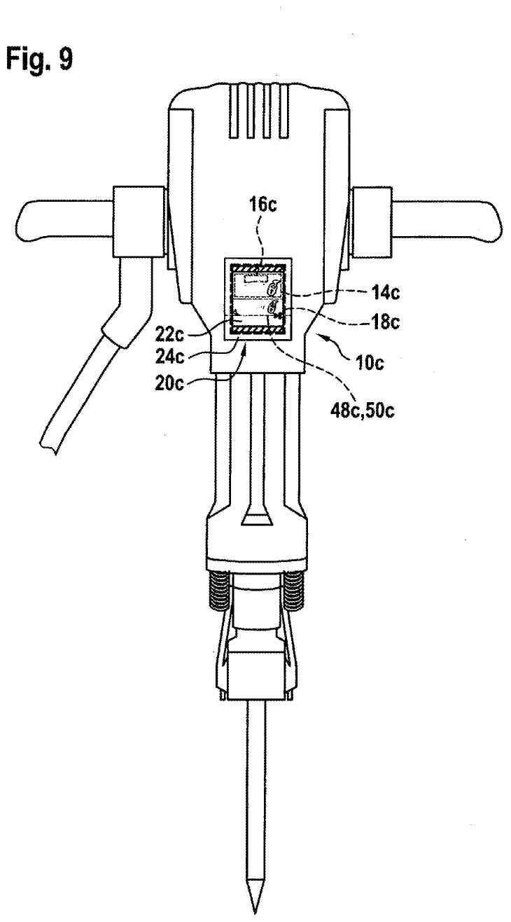

FIG. 9 a durable good, in particular a power tool, with a sealing device according to the invention, in a schematic representation.

### DESCRIPTION OF THE EXEMPLARY EMBODIMENTS

FIG. 1 shows a storage and/or packaging device 12a for durable goods (not represented in greater detail here), in particular power tools, having at least one sealing device 10a. For the purpose of explaining an operating principle of the storage and/or packaging device 12a, the storage and/or packaging device 12a represented in FIG. 1 is exemplarily realized as a case, in particular as a hand-held tool case. However, the storage and/or packaging device 12a is not intended to be limited to this design variant. It is conceivable for the storage and/or packaging device 12a also to be of a different design, considered appropriate by persons skilled in the art, that is intended to receive a durable good, in particular a power tool.

The storage and/or packaging device 12a preferably comprises a basic body unit 30a. The basic body unit 30a, in particular in the exemplary embodiment represented in FIG. 1, has a basic body element realized as a lid element 34a, and a further basic body element realized as a receiving element 36a. The lid element 34a is preferably pivotally mounted on the receiving unit 36a by means of a bearing unit (not represented in greater detail here). The receiving element 36a is designed to receive a durable good (not represented in greeter detail here), in particular a power tool, and/or accessories (not represented in greater detail here) of the durable good, in a manner already known to persons skilled in the art. The lid element 34a is preferably designed to cover, or close, a receiving region in which the durable good can be arranged, in a manner already known to persons skilled in the art. The storage and/or packaging device 12a preferably also has a closure unit 38a, which is designed to close the storage and/or packaging device 12a in a manner already known to persons skilled in the art, in particular to secure the lid element 34a against an opening movement relative to the receiving element 36a. The closure unit 38a preferably comprises at least one closure flap 40a, in particular at least two closure flaps 40a, 42a, mounted in a movable manner on the lid element 34a or on the receiving element 36a. The storage and/or packaging device 12a preferably comprises at least one, in particular further, security and/or seal label 44a (indicated only by a broken line in FIG. 1), which is arranged on at least one closure flap 40a, 42a of the closure unit 38a, in particular in such a manner that, in a manner already known to persons skilled in the art, a first-time opening of the closure unit 38a results in damage to the security and/or seal label 44a. The security and/or seal label 44a may comprise information contained as a durable-good ID, information realized as a durable-good designation, or other information considered appropriate by persons skilled in the art, such as, for example, a barcode to be read by means of a cash register, or the like.

The sealing device 10a for sealing that at least one storage and/or packaging device 12a for durable goods, in particular power tools, and/or for sealing at least one item of information, preferably comprises at least one information carrier unit 14a for receiving at least one item of information and/or one security key 16a, in particular a durable-good-specific item of information and/or a durable-good-specific security key, and at least one fixing unit 18a, in particular at least one adhesive unit, for fixing at least the information carrier unit 14a to the storage and/or packaging device 12a. The sealing device 10a preferably comprises at least one sealing unit 20a for an at least substantially irreversible visualization of a first-time viewing of the information carrier unit 14a and/or a first-time opening of the storage and/or packaging device 12a, wherein the sealing unit 20a, in at least one sealing state, covers at least the information carrier 14a unit in a visually protected manner. The sealing device 10a, in at least one sealing state, is arranged on, in particular stuck to, the lid element 34a and the receiving element 36a, in particular by means of the sealing unit 20a, in a manner already known to persons skilled in the art.

The information carrier unit 14a is preferably realized as a booklet. Preferably, in at least one sealing state of the sealing unit 20a, the booklet is arranged, folded up, on the fixing unit 18a, in particular between the fixing unit 18a and the sealing unit 20a. Preferably, the information carrier unit 14a, realized as a booklet, has at least one filing interface 46a (see FIGS. 3 and 4) such as, for example, a perforation for filing in a file folder. The information and/or the security key 16a, in particular the durable-good-specific information and/or the durable-good-specific security key, may be imprinted, glued, embossed, etched or impressed, on/in at least one information carrier element of the information carrier unit, or arranged on the information carrier unit in any other manner considered appropriate by persons skilled in the art. Preferably, the information and/or the security key 16a, in particular the durable-good-specific information and/or the durable-good-specific security key, is/are arranged on the information carrier element in the form of a machine-readable code such as, for example, a QR code, a data matrix code, a barcode or the like. Preferably the information and/or the security key 16a, in particular the durable-good-specific information and/or the durable-good-specific security key, is/are designed to be used to assign a durable good, in particular a power tool, to a user and/or to generate a certificate of a durable good, in particular a power tool, in particular as a result of an input and/or a transmission to a data processing centre, in particular via a mobile acquisition unit (not represented in greater detail here) such as, for example, a mobile telephone, in particular a smartphone. The information carrier unit 14a may comprise further items of information, in the form of a notice and/or instructions for use of the information and/or of the security key 16a, in particular for input in and/or transmission to a data processing centre by means of a mobile acquisition unit (see FIGS. 3 and 4). The information and/or security key 16a of the information carrier unit 14a that is covered in a visually protected manner by means of the sealing unit 20a, in at least one sealing state, can be used as a durable-good-specific code for registering the durable good, in particular the power tool, arranged in the storage and/or packaging device 12a.

The sealing unit 20a comprises at least one covering element 22a which, in at least one sealing state of the sealing unit 20a, covers at least the information carrier unit 14a in a visually protected manner, and at least one indication element 24a, which is arranged on the covering element 22a and which is at least partially transparent (see FIG. 2). The indication element 24a comprises at least one adhesive layer, which is provided for fixing the sealing unit 20a, in particular together with the information carrier unit 14a and/or the fixing unit 18a, to the storage and/or packaging device 12a. Preferably, the indication element 24a is realized as an adhesive film, which covers the covering element 22a and/or is arranged on, in particular stuck to, the covering element 22a. For at least substantially irreversible visualization of a first-time viewing of the information carrier unit 14a and/or a first-time opening of the storage and/or packaging device 12a, the indication element 24a can preferably be changed haptically and/or optically, wherein, in at least one sealing state of the sealing unit 20a, the indication element 24a at least partially surrounds the information carrier unit 14a (see FIGS. 1 and 2). The covering element 22a is preferably non-transparent. The indication element 24a preferably covers the covering element 22a completely. The indication element 24a preferably forms a top layer of the sealing unit 20a, in at least one sealing state of the sealing unit 20a. It is also conceivable, however, for the indication element 24a to be formed on the covering element 22a at side edges of the covering element 22a, and the covering element 22a, together with the indication element 24a, to form a top layer of the sealing unit 20a, in at least one sealing state of the sealing unit 20a. The covering element 22a is preferably connected to the indication element 24a in a materially bonded manner, in particular stuck onto the indication element 24a. It is also conceivable, however, for the covering element 22a and the indication element 24a to be to be realized as a single piece with each other, in particular to be realized as one film layer. In particular, at least the covering element 22a comprises a predetermined parting point 48a, in particular a sealing parting point such as, for example, a perforation, a tear-open strip or the like.

Preferably, at least the indication element 24a comprises a predetermined parting point 50a, in particular a seal parting point, such as a perforation, a tear-open strip or the like. Preferably, the predetermined parting point 48a of the covering element 22a and the predetermined parting point 50a of the indication element 24a are arranged congruently in at least one sealing state of the sealing unit 20a.

The sealing unit 20a and/or the information carrier unit 14a comprise/comprises at least one parting point 26a, 28a for non-destructive parting of the sealing unit 20a and/or of the information carrier unit 14a from the fixing unit 18a which, in at least one sealing state of the sealing unit 20a, is covered by the sealing unit 20a so as to be protected from access. The fixing unit 18a comprises at least one fixing element 52a, in particular an adhesive layer, and at least one base element 54a, which is designed to receive information (see FIGS. 3 and 4). The fixing element 52a may be realized as one piece, in particular as one layer, with the base element 54a, or the fixing element 52a and the base element 54a may be realized as separate elements that are fixed to each other by means of a force-locking, form-locking and/or materially bonded connection. Preferably, the fixing element 52a overlaps the base element 54a on at least two sides, in particular as viewed in one plane. A maximum extent of the fixing unit 18a is preferably less than a maximum extent of the sealing unit 20a, in particular in order that the fixing unit 18a is securely covered by the sealing unit 20a, in particular in at least one sealing state of the sealing unit 20a. The parting point 26a, 28a of the sealing unit 20a and/or of the information carrier unit 14a may be realized, for example, as a perforation, as a tear-open strip or the like. Preferably, the information carrier unit 14a and the sealing unit 20a are fixed to the fixing unit 18a, in particular detachably fixed to the fixing unit 18a via the parting point 26a, 28a of the sealing unit 20a and/or of the information carrier unit 14a, and can be removed from the fixing unit 18a as a result of severing of the parting point 26a, 28a of the sealing unit 20a and/or of the information carrier unit 14a, in an opened state, in particular in a broken-seal state, of the sealing unit 20a.

The fixing unit 18a comprises at least one item of information, corresponding to the information carrier unit 14a, and/or security key 32a, corresponding to the information carrier unit 14a, which, in at least one sealing state of the sealing device 20a and/or in a broken-seal state of the sealing device 20a, are/is arranged in a visually protected manner on the basic body unit 30a. The item of information, corresponding to the information carrier unit 14a, and/or the security key 32a, corresponding to the information carrier unit 14a, of the fixing unit 18a are/is preferably arranged on the base element 54a of the fixing unit 18a, in particular on a side of the base element 54a that faces toward the fixing element 52a. Preferably, in at least one sealing state of the sealing unit 20a, the item of information, corresponding to the information carrier unit 14a, and/or the security key 32a, corresponding to the information carrier unit 14a, of the fixing unit 18a are/is arranged on the base element 54a on a side of the base element 54a of the fixing unit 18a that faces away from the sealing unit 20a.

FIG. 5 shows a flow diagram of a method relating to arrangement of the sealing device 10a on the storage and/or packaging device 12a and/or to generation of the information and/or security key 16a and the corresponding information and/or corresponding security key 32a.

Preferably, in at least one method step, during a production and/or packaging process, digital data records are generated, which are combined in a durable-good-specific manner. The data records are preferably intended as a digital identity of durable goods. Preferably, the data records are combined in a durable good-specific manner at a production station by means of a data processing unit (not represented in greater detail here) and stored in a database. Preferably, the data records comprise at least one durable-goods ID, which preferably is derived from a serial number of the durable good, a telematics number, obtained from a telematics system integrated in the durable good, and/or an initial activation code, which can be used for an, in particular first, activation of the durable good and is preferably received by the information carrier unit 14a. In a practical implementation of the method, it is conceivable that the particular variant of a storage and/or packaging device 12a can be entered, by means of an input unit, at a packaging workstation in a production process at which the durable good is assembled. Preferably, the durable-good ID is acquired before or during insertion of the durable good, and transmitted to the data processing unit and/or the database, for example by read-out of a code arranged on the durable good, or by wireless transmission of electronic data, in particular by means of NFC, RFID,

Bluetooth or the like. Preferably, an initial activation code, which is preferably received by the information carrier unit 14a, in particular imprinted on it, is generated in dependence on the durable-good ID.

Preferably, in at least one method step 60a, a durable-good ID 56a of a durable good arranged in the storage and/or packaging device 12a, an accessory ID, a position-unit and/or communication-unit activation ID 58a, the information and/or security key 16a are/is acquired for the purpose of activating the durable good, in particular by means of an acquisition unit. Preferably, monitoring of an acquisition process may be provided, such that, in particular, it can be identified whether acquisition has been effected. Preferably, in particular following acquisition of the durable-good ID 56a and/or of the position-unit and/or communication-unit activation ID 58a, the durable good is arranged in the storage and/or packaging device 12a. It is also conceivable, however, for the durable-good ID 56a and/or the position-unit and/or communication-unit activation ID 58a to be acquired, in particular acquired automatically, when the durable good has been arranged in the storage and/or packaging device 12a. In particular, the acquired the durable-good ID 56a, position-unit and/or communication-unit activation ID 58a and information and/or security key 16a are transmitted to a data processing centre, and stored there. At least one verification check may be effected, in which completeness of the data record can be verified. Preferably, the data record is realized as a digital identity of the durable good. Preferably, in particular following the generation of the data record, the storage and/or packaging device 12a is closed, and sealed by means of the sealing device 10a, in particular in that the fixing unit 18a and/or the sealing unit 20a is stuck onto the storage and/or packaging device 12a. It is conceivable for the further security and/or seal label 44a to be attached to the closure unit 38a, in particular for the purpose of separately sealing the closure unit 38a.

FIG. 6 shows a flow diagram of a method relating to an assignment and/or certificate generating process by a commercial merchant. The method is preferably intended for automatically assigning a durable good, in particular a power tool, to a user, and/or for automatically generating a certificate of a durable good, in particular a power tool, in particular by use of a sealing device 10a. Following receipt of the storage and/or packaging device 12a sealed by means of the sealing device 10a, the merchant opens the sealing unit 20a, for example by means of a knife, scissors, or other item considered appropriate by persons skilled in the art, in particular to enable the information and/or security key 16a to be viewed. In at least one method step, the information and/or the security key 16a is acquired by means of a mobile acquisition unit, in particular by use of an application that can be run on the mobile acquisition unit realized as a smartphone. In at least one method step, an item of information received by the security and/or seal label 44a, in particular a durable-good ID, is acquired by means of the acquisition unit, in particular by use of an application that can be run on the mobile acquisition unit realized as a smartphone. At least the acquired durable-good ID and the acquired information and/or the acquired security key 16a are transmitted to the data processing centre for verification. Preferably, in particular subsequently, verification is performed by the data processing centre to determine wither the durable-good ID and the acquired information and/or the acquired security key 16a have already been entered, together or individually, at an earlier point in time. A user ID query is preferably started, in particular following clearance of the durable-good ID and of the acquired information and/or of the acquired key 16a, with an authorization of the merchant being performed to determine whether the merchant is authorized to enter the durable-good ID and the acquired information and/or the acquired security key 16a for the user. A verification of the entered and/or transmitted data is preferably carried out, in particular subsequently, by means of the data processing centre. In at least one method step, a certificate that defines, for example, a start timepoint of a guarantee, service and/or warranty period, is generated, in particular by means of the data processing centre, in dependence on an input and/or a transmission of at least the information and/or security key 16a of the durable good, in particular the power tool, received by the information carrier unit 14a of the sealing device 10a, and in dependence on an identification of the durable good, in particular the power tool. The storage and/or packaging device 12a can be handed over to a user in an activated state, sealed by means of the security and/or sealing label 44a.

FIG. 7 shows a flow diagram of a method relating to an assignment and/or certificate generating process by a user. The method is preferably intended for automatically assigning a durable good, in particular a power tool, to the user, and/or for automatically generating a certificate of a durable good, in particular a power tool, in particular by use of a sealing device 10a. Following acquisition of the storage and/or packaging device 12a sealed by means of the sealing device 10a, the user opens the sealing unit 20a, for example by means of a knife, scissors, or other item considered appropriate by persons skilled in the art, in particular to enable the information and/or security key 16a to be viewed. In at least one method step, the information and/or the security key 16a is acquired by means of a mobile acquisition unit, in particular by use of an application that can be run on the mobile acquisition unit realized as a smartphone. In at least one method step, an item of information received by the security and/or seal label 44a, in particular a durable-good ID, is acquired by means of the acquisition unit, in particular by use of an application that can be run on the mobile acquisition unit realized as a smartphone. At least the acquired durable-good ID and the acquired information and/or the acquired security key 16a are transmitted to the data processing centre for verification. Preferably, in particular subsequently, verification is performed by the data processing centre to determine wither the durable-good ID and the acquired information and/or the acquired security key 16a have already been entered, together or individually, at an earlier point in time. In at least one method step, a certificate that defines, for example, a start timepoint of a guarantee, service and/or warranty period, or that is realized as a promotion certificate or the like, is generated, in particular by means of the data processing centre, in dependence on an input and/or a transmission of at least the information and/or security key 16a of the durable good, in particular the power tool, received by the information carrier unit 14a of the sealing device 10a, and in dependence on an identification of the durable good, in particular the power tool. Preferably, in particular following validation of the durable-good ID and of the acquired information and/or the acquired security key 16a, a notice is automatically issued to the user, in particular via the mobile acquisition unit, that the assignment was successful and/or that the generation of the certificate was successful. In at least one method step, a communication unit and/or position data unit (not represented in greater detail here) of the durable good, in particular of the power tool, is activated automatically in dependence on an input and/or a transmission of at least the information and/or security key 16a of the durable good, in particular the power tool, received by the information carrier unit 14a of the sealing device 10a, and in dependence on an identification of the durable good, in particular the power tool.

FIGS. 8 and 9 show further exemplary embodiments of the invention. The following descriptions and the drawings are limited substantially to the differences between the exemplary embodiments and, in principle, reference may be made to the drawings and/or the description of the other exemplary embodiments, in particular of FIGS. 1 to 7, in respect of components having the same designation, in particular in respect of components having the same reference numerals. To distinguish the exemplary embodiments, the letter a has been appended to the references of the exemplary embodiment in FIGS. 1 to 7. In the exemplary embodiments of FIGS. 8 and 9, the letter a has been replaced by the letters b and c.

FIG. 8 shows a storage and/or packaging device 12b for durable goods (not represented in greater detail here), in particular power tools, having at least one sealing device 10b. The sealing device 10b, for sealing the at least one storage and/or packaging device 12b for durable goods, in particular power tools, and/or for sealing at least one item of information, comprises at least one information carrier unit 14b for receiving at least one item of information and/or one security key 16b, in particular a durable-good-specific item of information and/or a durable-good-specific security key, and at least one fixing unit 18b, in particular at least one adhesive unit, for fixing at least the information carrier unit 14b to the storage and/or packaging device 12b. The sealing device 10b comprises at least one sealing unit 20b for an at least substantially irreversible visualization of a first-time viewing of the information carrier unit 14b and/or a first-time opening of the storage and/or packaging device 12b, wherein the sealing unit 20b, in at least one sealing state, covers at least the information carrier 14b unit in a visually protected manner. Unlike the storage and/or packaging device 12a represented and described in FIGS. 1 to 7, the storage and/or packaging device 12b represented in FIG. 8 is realized as a cardboard box packaging for durable goods. It is also conceivable, however, for the storage and/or packaging device 12b to be of a different design, considered appropriate by persons skilled in the art. Regarding further features of the storage and/or packaging device 12b represented in FIG. 8, and of the sealing device 10b, and a possible use of the sealing device 10b, reference may be made to the description of FIGS. 1 to 7, which is to be read by analogy to FIG. 8.

FIG. 9 shows a durable good, in particular a power tool, having at least one sealing device 10c. The sealing device 10c, for sealing at least one item of information, comprises at least one information carrier unit 14c for receiving at least one item of information and/or one security key 16c, in particular a durable-good-specific item of information and/or a durable-good-specific security key, and at least one fixing unit 18c, in particular at least one adhesive unit, for fixing at least the information carrier unit 14c to the durable good, in particular to an exterior of a housing of the power tool.

The sealing device 10c comprises at least one sealing unit 20c for an at least substantially irreversible visualization of a first-time viewing of the information carrier unit 14c and/or a first-time opening of the storage and/or packaging device 12c, wherein the sealing unit 20c, in at least one sealing state, covers at least the information carrier 14c unit in a visually protected manner. The durable good, in particular the power tool, may be arranged in a storage and/or packaging device (not represented in greater detail here) such as that described, for example, in the description of FIGS. 1 to 8. A method for assigning the durable good, in particular the power tool, to a user, and/or for generating a certificate of the durable good, in particular of the power tool, preferably proceeds in a manner substantially analogous to that of the method described in the description of FIGS. 5 to 7. Regarding further features of the sealing device 10c represented in FIG. 9, and a possible use of the sealing device 10c, reference may be made to the description of FIGS. 1 to 7, which is to be read by analogy to FIG. 9.

1. A sealing device for sealing at least one storage and/or packaging device for a durable good and/or for sealing at least one item of information, the sealing device comprising:
at least one information carrier unit configured to receive the at least one item of information and/or a security key; in particular durable
at least one fixing unit configured to fix at least the at least one information carrier unit to the at least one storage and/or packaging device or to the durable good and
at least one sealing unit configured for an at least substantially irreversible visualization of a first-time viewing of the at least one information carrier unit and/or a first-time opening of the at least one storage and/or packaging device,
wherein the at least one sealing unit, in at least one sealing state, covers at least the at least one information carrier unit in a visually protected manner.

2. The sealing device as claimed in claim 1, wherein the at least one sealing unit comprises:
at least one covering element which, in the at least one sealing state, covers at least the at least one information carrier unit in the visually protected manner, and
at least one indication element arranged on the at least one covering element, the at least one indication element at least partially transparent.

3. The sealing device as claimed in claim 1, wherein:
the at least one sealing unit comprises at least one indication element which, for the at least substantially irreversible visualization of the first-time viewing of the at least one information carrier unit and/or the first-time opening of the at least one storage and/or packaging device, is changed haptically and/or optically, and,
in the at least one sealing state, the at least one indication element at least partially surrounds the at least one information carrier unit.

4. The sealing device as claimed in claim 1, wherein the at least one sealing unit and/or the at least one information carrier unit have/has at least one parting point configured for non-destructive parting of the at least one sealing unit and/or of the at least one information carrier unit from the at least one fixing unit which, in the at least one sealing state, is covered by the at least one sealing unit so as to be protected from access.

5. The sealing device as claimed in claim 1, wherein the at least one item of information and/or the security key of the at least one information carrier unit that is covered in the visually protected manner by the at least one sealing unit, in the at least one sealing state, is usable as a durable-good-specific code configured for registering the durable good arranged in the at least one storage and/or packaging device.

6. The sealing device as claimed in claim 1, wherein:
the durable good is a a power tool.

7. A storage and/or packaging system, in comprising:
at least one storage and/or packaging device for a durable good; and
at least one sealing device for sealing the at least one storage and/or packaging device and/or for sealing at least one item of information, the sealing device comprising:
at least one information carrier unit configured to receive the at least one item of information and/or a security key,
at least one fixing unit configured to fix at least the at least one information carrier unit to the at least one storage and/or packaging device or to the durable good, and
at least one sealing unit configured for an at least substantially irreversible visualization of a first-time viewing of the at least one information carrier unit and/or a first-time opening of the at least one storage and/or packaging device,
wherein the at least one sealing unit, in at least one sealing state, covers at least the at least one information carrier unit in a visually protected manner.

8. The storage and/or packaging system as claimed in claim 7, wherein:
the at least one storage and/or packaging device includes at least one basic body unit, and
the at least one fixing unit has the at least one item of information, corresponding to the at least one information carrier unit, and/or the security key, corresponding to the at least one information carrier unit, which, in the at least one sealing state and/or in a broken-seal state of the at least one sealing device, are/is arranged in the visually protected manner on the at least one basic body unit.

9. A method for assigning a durable good to a user and/or for generating a certificate of the durable good using a sealing device, the method comprising:
sealing at least one storage and/or packaging device for the durable good and/or sealing at least one item of information for the durable good with the sealing device by
receiving the at least one item of information and/or a security key with at least one information carrier unit of the sealing device;
fixing at least the at least the at least one information carrier unit to the at least one storage and/or packaging device or to the durable good with at least one fixing unit
at least substantially irreversibly visualizing a first-time viewing of the at least one information carrier unit and/or a first-time opening of the at least one storage and/or packaging device with at least one sealing unit of the sealing device; and
in at least one sealing state, covering at least the at least one information carrier unit in a visually protected manner with the at least one sealing unit.

10. The method as claimed in claim 9, further comprising:
generating the certificate in dependence on an input and/or a transmission of the at least one item of information and/or the security key of the durable good, and in dependence on an identification of the durable good.

11. The method as claimed in claim 9, further comprising:
activating automatically a communication unit and/or a position data unit of the durable good in dependence on an input and/or a transmission of the at least one item of information and/or the security key of the durable good received by the at least one information carrier unit, and in dependence on an identification of the durable good.

12. The method as claimed in claim 9, wherein the durable good is a power tool.

13. The sealing device as claimed in claim 1, wherein the at least one item of information and/or the security key includes information specific to the durable good and/or a security key specific to the durable good.

14. The sealing device as claimed in claim 1, wherein the at least one fixing unit includes an adhesive unit.
